(19) United States
(12) Patent Application Publication
(10) Pub. No.: US 2015/0220072 A1
(43) Pub. Date: Aug. 6, 2015

(54) INFORMATION PROCESSING DEVICE, COMPUTER PROGRAM PRODUCT, AND INFORMATION PROCESSING METHOD

(71) Applicant: Kabushiki Kaisha Toshiba, Tokyo (JP)

(72) Inventors: Noriyuki HIRAYAMA, Fuchu Tokyo (JP); Satoshi ODAKURA, Yokohama Kanagawa (JP)

(21) Appl. No.: 14/573,206

(22) Filed: Dec. 17, 2014

(30) Foreign Application Priority Data
Jan. 31, 2014 (JP) 2014-017885

(51) Int. Cl. G05B 15/02

(52) U.S. Cl. CPC G05B 15/02

(57) ABSTRACT

According to one embodiment, an information processing device includes to a receiver, a display controller, an acquisition module, a storage module, and a setting module. The receiver receives a selection of a control target device and an input of control information to be set for the control target device. The display controller controls display of a first screen for inputting the control information on a display. The acquisition module detects an activated external device and acquires a unique identifier after the receiver receives the input of the control information completely. The storage module stores the unique identifier for each registered device for which the control information is already set. The setting module sets the received control information for the external device when a first device of the registered device is selected as the control target device and the identifier of the external device coincides with the identifier of the first device. When the identifier of the first device does not coincide with the identifier of the external, the display controller controls display of a notification relating to non-coincidence on the display.

### CROSS-REFERENCE TO RELATED APPLICATIONS

This application is based upon and claims the benefit of priority from Japanese Patent Application No. 2014-017885, filed Jan. 31, 2014, the entire contents of which are incorporated herein by reference.

### FIELD

Embodiments described herein relate generally to an information processing device, a computer program product, and an information processing method.

### BACKGROUND

Disclosed have been techniques of setting control information to a control target device such as a home electrical appliance using an operation terminal (an example of an information processing device) such as a tablet terminal and a smartphone.

In the conventional techniques, when the control information is set to the control target device by use of the operation terminal, the control information cannot be input until a setting screen that is used for inputting the control information to the control target device is displayed after the control target device is activated and an device ID of the control target device becomes acquirable. Furthermore, in the case where the setting screen is displayed before the control target device is activated, when a control target device previously selected as a setting destination of the control information input by use of the setting screen does not coincide with the activated control target device, the control information is set to the control target device that is not intended by a user.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating the configuration of an information processing system comprising an information processing device according to a first embodiment;

FIG. 2 is an exemplary diagram illustrating the hardware configuration of an operation terminal in the first embodiment;

FIG. 3 is an exemplary block diagram illustrating the functional configuration of the operation terminal in the first embodiment;

FIG. 4 is an exemplary view illustrating an example of a control information input screen that is displayed on the operation terminal in the first embodiment;

FIG. 5 is an exemplary flowchart illustrating the flow of processing of setting control information to an external device by the operation terminal in the first embodiment;

FIG. 6 is an exemplary view illustrating another example of the control information input screen that is displayed on the operation terminal in the first embodiment;

FIG. 7 is an exemplary flowchart illustrating the flow of the processing of setting the control information to an external device by the operation terminal in the first embodiment;

FIG. 8 is an exemplary view illustrating an example of an error message that is displayed on the operation terminal comprised in the information processing system in the first embodiment;

FIG. 9 is an exemplary flowchart illustrating the flow of processing of setting the control information to an external device by an operation terminal according to a second embodiment; and

FIG. 10 is an exemplary flowchart illustrating the flow of processing of setting the control information to an external device by an operation terminal according to a third embodiment.

### DETAILED DESCRIPTION

In general, according to one embodiment, an information processing device comprises to a receiver, a display controller, an acquisition module, a storage module, and a setting module. The receiver receives a selection of a control target device and an input of control information to be set for the control target device. The display controller controls display of a first screen for inputting the control information on a display. The acquisition module detects an activated external device and acquires a unique identifier after the receiver receives the input of the control information completely. The storage module stores the unique identifier for each registered device for which the control information is already set. The setting module sets the received control information for the external device when a first device of the registered device is selected as the control target device and the identifier of the external device coincides with the identifier of the first device. When the identifier of the first device does not coincide with the identifier of the external, the display controller controls display of a notification relating to non-coincidence on the display.

The following describes an information processing device, a computer program product, and an information processing method according to embodiments with reference to the accompanying drawings.

### First Embodiment

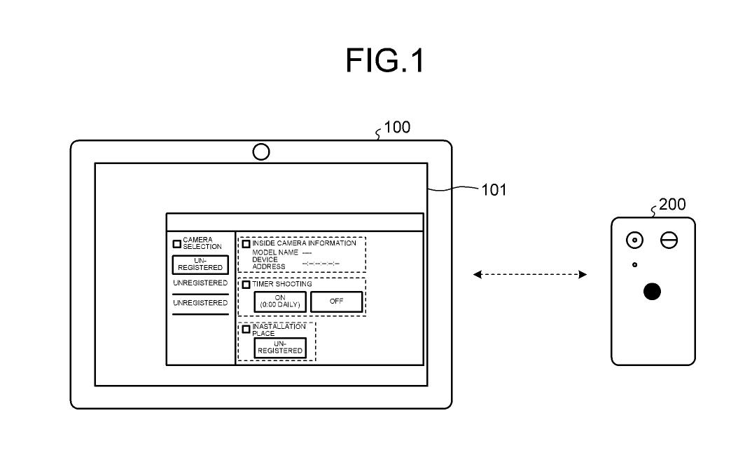

FIG. 1 is a view illustrating the configuration of an information processing system comprising an information processing device according to a first embodiment. As illustrated in FIG. 1, the information processing system in the embodiment comprises an operation terminal 100 (an example of the information processing device) that comprises a display device 101 capable of displaying various pieces of information and a communication interface communicating with external device which will be described later, and an inside camera 200 (for example, camera installed in a chiller or the like of a refrigerator and shooting the inside of the refrigerator) that is an example of the external devices that are controlled by the operation terminal 100.

In the embodiment, the operation terminal 100 and the inside camera 200 comprise a communication interface for wireless communication such as Bluetooth (registered trademark) and wireless fidelity (WiFi) or a communication interface for wired communication such as Ethernet (registered trademark). The operation terminal 100 and the inside camera 200 communicate with each other using an ECHONET Lite communication protocol as a communication protocol.

The ECHONET Lite communication protocol is a protocol proposed for managing in-home external devices (for example, inside camera 200) unitarily in an in-home energy management system called home energy management system (HEMS). Although the ECHONET Lite communication protocol is used as the communication protocol that is used for communication between the operation terminal 100 and the external devices in the embodiment, the communication protocol is not limited thereto and other communication protocols may be used.

The operation terminal 100 comprises a personal computer (PC), a tablet terminal, a smartphone, or the like. The operation terminal 100 communicates with the external device such as the inside camera 200 in accordance with the ECHONET Lite communication protocol, so that status information can be acquired indicating a status of the external device (for example, activation of the inside camera 200), set control information (in other words, control information that is set to the external device) to be used for controlling the external device, and the like.

The status information is information indicating the status of the external device, for example, indicating activation of the external device. In the embodiment, the status information includes identification information (for example, a model number of the inside camera 200 and an device address as a network address of the inside camera 200) as an example of a unique identifier by which the activated external device is recognizable.

The control information is information for controlling the external device, for example, indicating ON/OFF of a timer shooting function of shooting at a previously set timing such as once a day, a shooting timing which is a timing (for example, once a day) that a shooting is performed by the timer shooting function, ON/OFF of a request shooting function of shooting in accordance with an operation with a shooting button comprised in the inside camera 200, and the like.

The inside camera 200 communicates with the operation terminal 100 in accordance with the ECHONET Lite communication protocol and therefore transmits the status information of the inside camera 200 to the operation terminal 100, receives the control information from the operation terminal 100, and the like. The inside camera 200 executes various types of functions such as the timer shooting function and the request shooting function in accordance with the control information received from the operation terminal 100.

In the embodiment, the inside camera 200 is driven with a battery (not illustrated). In order to prevent battery drain, the inside camera 200 is not activated and can't communicate with the operation terminal 100 until a power button (not illustrated) comprised in the inside camera 200 is operated and the inside camera 200 is directed to be powered ON. When the power button (not illustrated) is operated and the inside camera 200 is directed to be powered ON, the inside camera 200 is activated and made into a state where it can shoot the inside of the refrigerator. Thereafter, the inside camera 200 is automatically powered OFF when the power button (not illustrated) is operated and the inside camera 200 is directed to be powered OFF or a predetermined period of time (for example, one minute) elapses since final shooting.

In the embodiment, although the inside camera 200 is activated in accordance with the operation of the power button (not illustrated) comprised in the inside camera 200, the activation manner thereof is not limited thereto. The inside camera 200 may be also activated based on whether light (for example, light emitted from the operation terminal 100) received by a light sensor (not illustrated) comprised in the inside camera 200 turns on and off in a predetermined pattern.

When the timer shooting function is directed to be turned ON in accordance with the control information received from the operation terminal 100, the inside camera 200 may be activated and shoots the inside of the refrigerator at the shooting timing contained in the control information received from the operation terminal 100, and then, be powered OFF automatically after the predetermined period of time has elapsed since the shooting of the inside of the refrigerator.

When the request shooting function is directed to be turned ON in accordance with the control information received from the operation terminal 100, the inside camera 200 is activated in accordance with the operation of the power button (not illustrated), and then, shoots the inside of the refrigerator at a timing at which the shooting button (not illustrated) comprised in the inside camera 200 is pressed down. Thereafter, the inside camera 200 may be powered OFF automatically after the predetermined period of time in which the shooting button is not pressed down has elapsed since final shooting of the inside of the refrigerator.

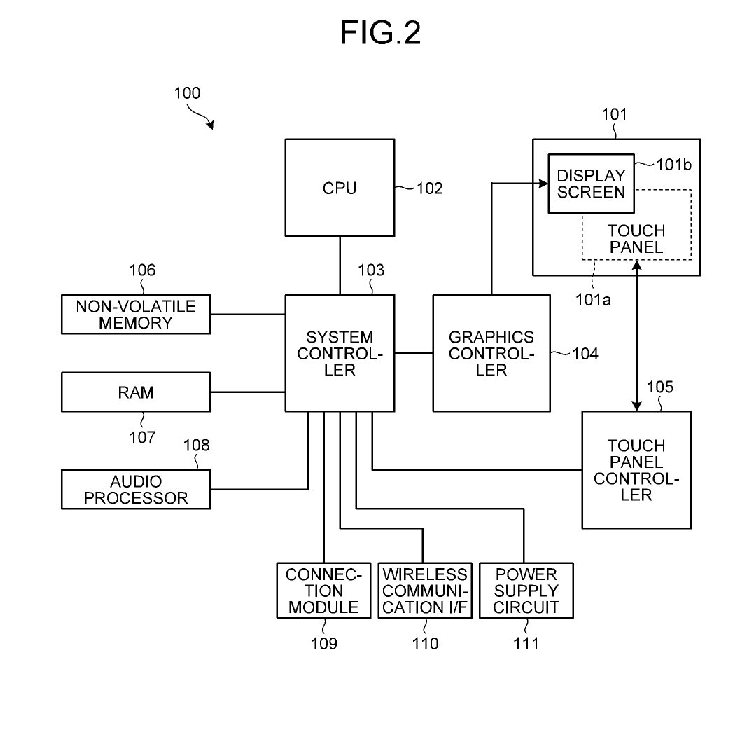

FIG. 2 is a diagram illustrating the hardware configuration of the operation terminal in the first embodiment. In the embodiment, as illustrated in FIG. 2, the operation terminal 100 comprises the display device 101, a central processing unit (CPU) 102, a system controller 103, a graphics controller 104, a touch panel controller 105, a non-volatile memory 106, a random access memory (RAM) 107, an audio processor 108, a connection module 109, a wireless communication I/F 110, and a power supply circuit 111.

The display device 101 comprises a touch panel 101a and a display screen 101b (an example of a display module) such as a liquid crystal display (LCD) and an organic electroluminescent (EL) display. The touch panel 101a has a position detection function of detecting a contact position onto the touch panel 101a, so that a contact position (touched position) can be detected on the display screen 101b that has been touched and specified with a finger or the like of the user of the operation terminal 100. The display device 101 functions as a what-is-called touch panel display with the position detection function of the touch panel 101a.

The system controller 103 incorporates therein a memory controller controlling accesses to the non-volatile memory 106 and the RAM 107. The system controller 103 also has a function of communicating with the graphics controller 104. The system controller 103 incorporates therein a microcomputer in which an embedded controller controlling the power supply circuit 111 for supplying electric power accumulated in a battery (not illustrated) comprised in the operation terminal 100 is integrated.

The graphics controller 104 is a display controller controlling display of various pieces of information on the display screen 101b. The touch panel controller 105 controls the touch panel 101a and acquires positional information indicating a touched position onto the touch panel 101a by a user from the touch panel 101a. Then, the touch panel controller 105 outputs the acquired positional information to the CPU 102 through the system controller 103.

The audio processor 108 performs audio processing including digital conversion, noise removal, echo cancellation or the like on an audio signal that is input from a microphone (not illustrated) and outputs the audio signal to the CPU 102. The audio processor 108 outputs an audio signal generated by performing audio processing such as audio synthesis under control by the CPU 102 to a speaker (not illustrated) for outputting audio through the speaker.

The connection module 109 is an interface that is connectable to a wired network such as Ethernet (registered trademark). In the embodiment, the operation terminal 100 may make communication with external devices such as the inside camera 200 through the wired network.

The wireless communication I/F 110 is a communication interface that makes communication with the external devices such as the inside camera 200 using a communication protocol such as Bluetooth (registered trademark), IEEE802.11b/g/n, and IEEE802.15.4.

The CPU 102 is a processor that centrally controls operations of the operation terminal 100 and controls the respective modules of the operation terminal 100 through the system controller 103. The CPU 102 executes an operating system (OS) and various programs that are loaded on the RAM 107 from the non-volatile memory 106. The RAM 107 provides an operation region as a main memory of the operation terminal 100 when the OS and the various programs stored in the non-volatile memory 106 are executed. The non-volatile memory 106 (an example of a storage module) stores therein identification information of equal to or more than one external device (hereinafter, referred to as the registered device) to which control information has been already set.

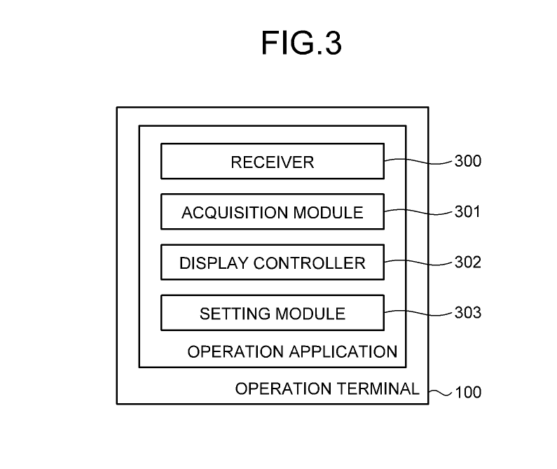

FIG. 3 is block diagram illustrating the functional configuration of the operation terminal in the first embodiment. In the embodiment, the CPU 102 reads out operation applications from the non-volatile memory 106 and executes them so as to establish a receiver 300, an acquisition module 301, a display controller 302, and a setting module 303 on the RAM 107.

The receiver 300 receives selection of a control target device as the external device that is controlled by setting control information thereto and input of control information that is set as the control information through an operation module such as the touch panel 101a. Furthermore, the receiver 300 can receive input of the control information even when the control target device is not selected. In the embodiment, the receiver 300 receives selection of the control target device and input of the control information by use of a control information input screen that is displayed on the display screen 101b by the display controller 302, which will be described later.

The acquisition module 301 detects the activated external device (for example, the inside camera 200) and acquires an identifier unique to the external device. The acquisition module 301 can also detect the activated external device and acquire the unique identifier after the receiver 300 has completely received the input of the control information. In the embodiment, the acquisition module 301 communicates with the external device in accordance with the ECHONET Lite communication protocol through the wireless communication I/F 110 (or connection module 109) and therefore receives the status information from the external device. When the status information received from the external device indicates activation of the external device, the acquisition module 301 detects the activation of the external device. The acquisition module 301 acquires the identification information contained in the status information received from the external device as the identifier unique to the external device.

The display controller 302 controls to display the control information input screen (an example of a first screen) that is a screen for inputting the control information on the display screen 101b (an example of the display module). In the embodiment, the display controller 302 controls to display the control information input screen as a screen (that can be used for inputting the control information) for inputting the control information to be set to the external device on the display screen 101b before the acquisition module 301 detects the activation of the external device. When the setting module 303, which will be described later, determines that identification information of a first device and identification information of the external device the activation of which has been detected do not coincide with each other, the display controller 302 controls to display notification relating to the non-coincidence on the display screen 101b.

When the external device the activation of which has been detected by the acquisition module 301 and an external device (hereinafter, referred to as control target device) that has been previously selected as a setting destination of the control information input by use of the control information input screen coincide with each other, the setting module 303 sets the control information (that is, control information the input of which has been received by the receiver 300) input by use of the control information input screen to the external device the activation of which has been detected. When the external device the activation of which has been detected and the control target device do not coincide with each other, the setting module 303 prohibits the control information input by use of the control information input screen from being set to the external device the activation of which has been detected. Furthermore, when the control target device as the setting destination of the control information input by use of the control information input screen is not selected, the setting module 303 cancels the prohibition of the setting of the control information input by use of the control information input screen to the external device and sets the control information to the external device.

In the embodiment, when the control information input by use of the control information input screen is set to the external device, the setting module 303 stores an installation place of the external device and the input control information in the non-volatile memory 106 in association with identification information (for example, a model number and an device address) of the external device (registered device) that is contained in the status information received from the external device when activation of the external device has been detected.

In other words, when the receiver 300 receives selection of the registered device (hereinafter, referred to as first device) as the control target device and the identification information of the external device the activation of which has been detected and the identification information of the first device coincide with each other, the setting module 303 sets the control information the input of which has been received by the receiver 300 to the external device the activation of which has been detected.

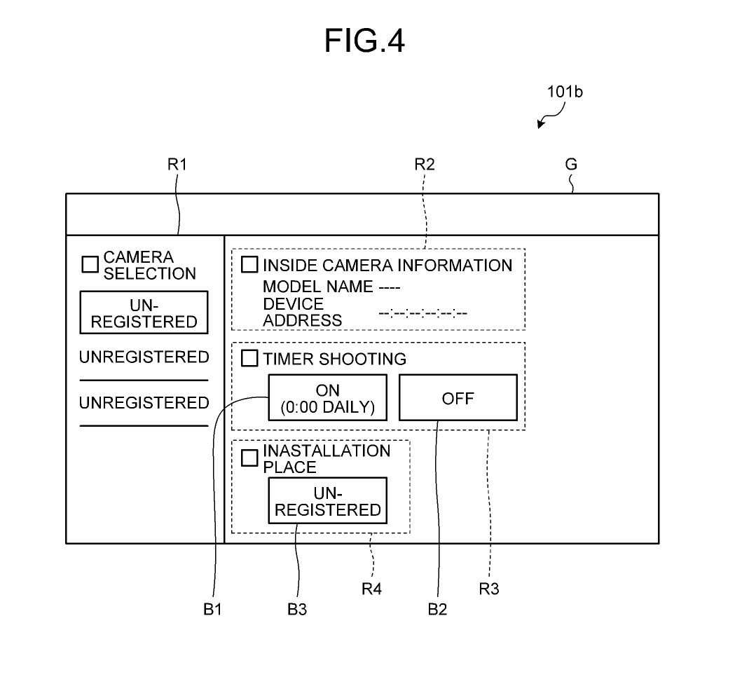

The following describes the control information input screen that is displayed on the display screen 101b of the operation terminal 100 in the embodiment with reference to FIG. 4. FIG. 4 is a view illustrating an example of the control information input screen that is displayed on the operation terminal in the first embodiment.

In the embodiment, as illustrated in FIG. 4, the display controller 302 controls to display a control information input screen G comprising a camera selection region R1, an inside camera information region R2, a control information input region R3, and an installation place setting region R4 on the display screen 101b.

The camera selection region R1 is a region usable for selecting the control target device (in the embodiment, inside camera 200) as the setting destination of the control information. In the embodiment, the predetermined number of (for example, three) installation places (for example, chiller) of control target devices that can be selected as the setting destinations of control information as the number of control target devices (registered devices) to which the control information can be set are displayed on the camera selection region R1. When there is no registered device or the number of registered devices is smaller than a predetermined number, information (for example, “unregistered”) indicating no registered device is displayed on the camera selection region R1 instead of the installation place of the control target device, as illustrated in FIG. 4.

A user of the operation terminal 100 touches and specifies an installation place of a control target device as the setting destination of the control information among the installation places displayed on the camera selection region R1 and therefore can select a control target device corresponding to the touched and specified installation place as the setting destination of the control information. The user of the operation terminal 100 touches and specifies “unregistered” displayed on the camera selection region R1 and therefore can direct to input control information without selecting the control target device as the setting destination of the control information.

The inside camera information region R2 is a region on which setting destination information (for example, the model name of the inside camera 200 and the device address of the inside camera 200) as the identification information by which the control target device as the setting destination of the control information is recognizable is displayed. When “unregistered” has been touched and specified on the camera selection region R1 and the control target device as the setting destination of the control information has not been selected, information (for example, “model name ----” as the model name of the inside camera 200 and “device address --:--:--:--:--:--” as the device address of the inside camera 200) indicating that the identification information of the control target device as the setting destination of the control information has not been selected is displayed on the inside camera information region R2 as the setting destination information.

The user of the operation terminal 100 checks the identification information displayed on the inside camera information region R2, so that he or she can check the control target device as the setting destination of the control information. In this way, the control information can be prevented from being set to the control target device that is not intended by the user.

The control information input region R3 is a region that can be used for inputting the control information that is set to the control target device. In the embodiment, a first button B1 (“on”) for inputting control information directing to turn ON the timer shooting function and a second button B2 (“off”) for inputting control information directing to turn OFF the timer shooting function are displayed on the control information input region R3.

The user of the operation terminal 100 touches and specifies the first button B1 or the second button B2, so that he or she can input the control information directing ON or OFF of the timer shooting function. In the embodiment, when the user touches and specifies the first button B1, the display controller 302 controls to display a timing setting screen (not illustrated) for inputting the shooting timing as the timing at which shooting is performed with the timer shooting function on the display screen 101b. When the user touches and specifies the first button B1, the display controller 302 includes the first button B1 displaying a shooting timing (for example, 0:00 every day) input on the timing setting screen in the control information input region R3.

The installation place setting region R4 is a region for directing to set the installation place selected on the camera selection region R1. In the embodiment, a third button B3 for directing to set the installation place selected on the camera selection region R1 is displayed on the installation place setting region R4. When the user touches and specifies the third button B3, the display controller 302 controls to display an installation place setting screen (not illustrated) that is a screen for setting the installation place and comprises a button (for example, radio button) for selecting the installation place.

When “unregistered” is touched and specified on the camera selection region R1, the control information is input without selecting the control target device as the setting destination of the control information, and activation of the external device is not detected, the setting module 303 cannot acquire identification information of the external device to which the input control information is set. In this case, even when the installation place is selected by use of the installation place setting screen (not illustrated), the selected installation place cannot be also stored in the non-volatile memory 106 in association with the identification information of the external device.

Accordingly, when the user inputs the control information without selecting the control target device as the setting destination of the control information and activation of the external device is not detected, the display controller 302 does not control to display the installation place setting screen (not illustrated) on the display screen 101b and prohibits the installation place from being selected even when the third button B3 is touched and specified.

In the embodiment, when the third button B3 is touched and specified, the display controller 302 controls to display the installation place setting screen (not illustrated) comprising the radio button for selecting the installation place on the display screen 101b. The screen that is displayed is not, however, limited thereto and it is sufficient that the display controller 302 controls to display a screen to which the installation place can be input. For example, the display controller 302 may control to display, as the installation place setting screen, a screen displaying a software keyboard for inputting the installation place on the display screen 101b.

The user of the operation terminal 100 touches and specifies the third button B3, so that he or she can direct to set the installation place of the control target device. The user of the operation terminal 100 touches and specifies the third button B3 so as to cause the installation place setting screen (not illustrated) to be displayed on the display screen 101b. The user of the operation terminal 100 then touches and specifies the radio button corresponding to the installation place on the installation place setting screen, so that he or she can set the installation place.

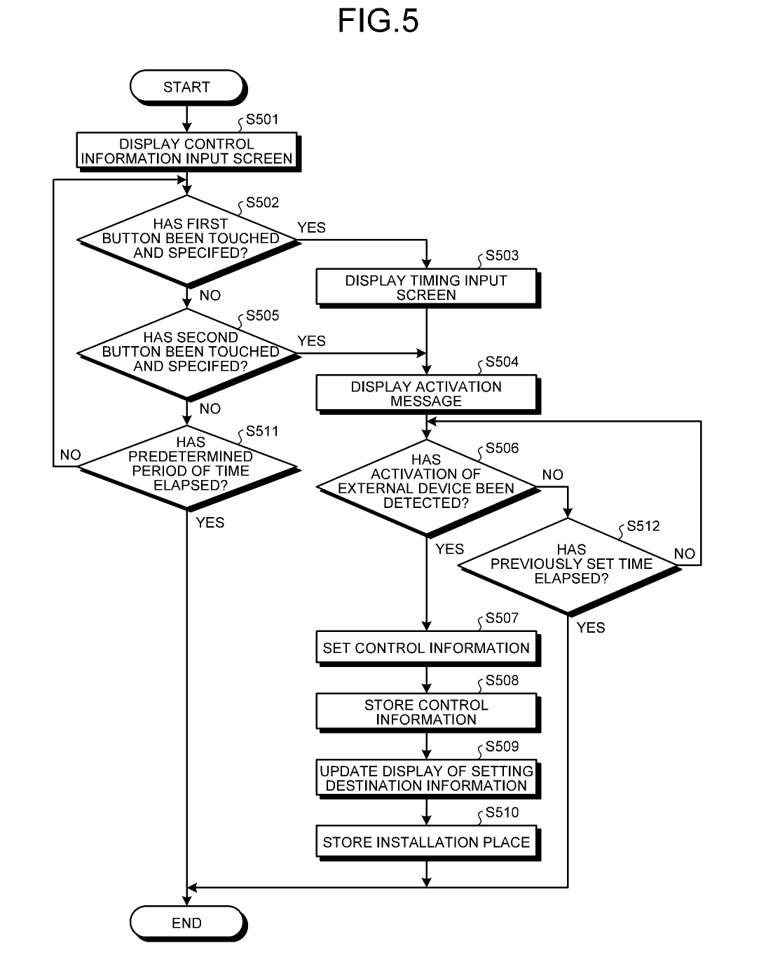

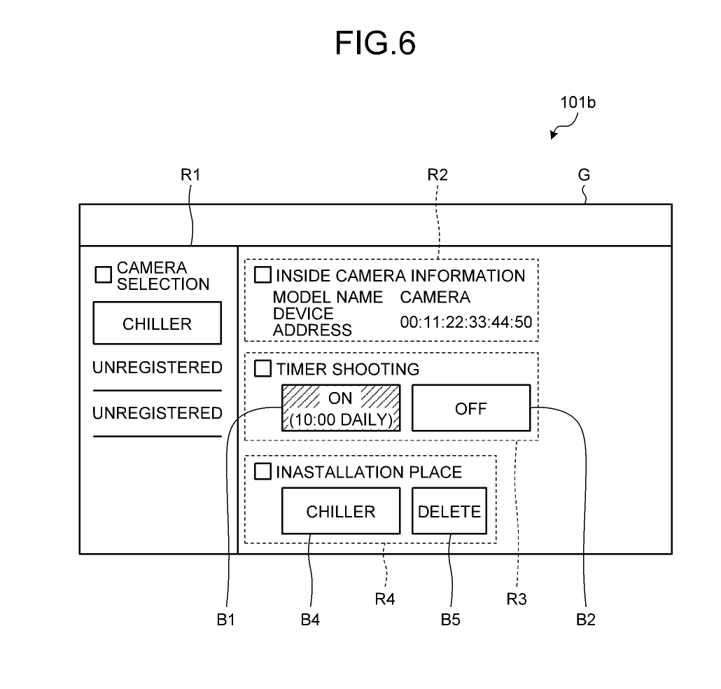

The following describes processing of setting the control information to the external device when a control target device as the setting destination of the control information is not selected (when “unregistered” is touched and specified on the camera selection region R1) with reference to FIG. 5 and FIG. 6. FIG. 5 is a flowchart illustrating the processing of setting the control information to the external device by the operation terminal in the first embodiment. FIG. 6 is a view illustrating an example of the control information input screen that is displayed on the operation terminal in the first embodiment.

When the control information is directed to be set through the touch panel 101a or the like, the display controller 302 controls to display the control information input screen G on the display screen 101b before the acquisition module 301 detects the external device (S501). In the embodiment, when “unregistered” is touched and specified on the camera selection region R1 and the control target device as the setting destination of the control information is not selected, the display controller 302 controls to display the setting destination information indicating that the control target device as the setting destination of the control information is not selected on the inside camera information region R2 as illustrated in FIG. 3.

The display controller 302 determines whether the first button B1 (“on”) displayed on the control information input region R3 of the control information input screen G has been touched and specified (S502). When the display controller 302 determines that the first button B1 has been touched and specified (Yes at S502), the display controller 302 controls to display the timing input screen (not illustrated) for inputting the shooting timing on the display screen 101b (S503). Thereafter, when the shooting timing is input and an OK button or the like directing to set the shooting timing is touched and specified on the timing input screen, the display controller 302 controls to display an activation message (for example, “Please activate the inside camera.”) directing to activate the external device on the display screen 101b (S504). In the embodiment, when the first button B1 (or the second button B2, which will be described later) is touched and specified and the control information (ON/OFF of the timer shooting function and the shooting timing herein) is input, the display controller 302 controls to display the activation message all the time regardless of whether the acquisition module 301 detects the activation of the external device. The invention is not, however, limited thereto and the activation message may be displayed only in the case where the acquisition module 301 has not detected the activation of the external device when the control information has been input.

On the other hand, when the first button B1 has not been touched and specified (No at S502), the display controller 302 determines whether the second button B2 (“off”) displayed on the control information input region R3 of the control information input screen G has been touched and specified (S505). When the display controller 302 determines that the second button B2 has been touched and specified (Yes at S505), the display controller 302 controls to display the activation message on the display screen 101b (S504). On the other hand, when the second button B2 has not been touched and specified (No at S505), the display controller 302 determines whether a predetermined period of time has elapsed since the first button B1 and the second button B2 have been displayed (S511). When the predetermined period of time has not elapsed since the first button B1 and the second button B2 have been displayed (No at S511), the process returns to S502 and the display controller 302 determines whether the first button B1 has been touched and specified. On the other hand, when the predetermined period of time has elapsed since the first button B1 and the second button B2 have been displayed (Yes at S511), the display controller 302 finishes display of the control information input screen G and finishes the processing of setting the control information to the external device.

After the first button B1 or the second button B2 is touched and specified and the control information (ON/OFF of the timer shooting function and the shooting timing in the embodiment) is input, the setting module 303 determines whether the acquisition module 301 has detected the activation of the external device (S506). When the setting module 303 determines that the acquisition module 301 has detected activation of the external device (Yes at S506), the setting module 303 transmits the control information input by use of the control information input screen G to the external device the activation of which has been detected by the acquisition module 301 through the wireless communication I/F 110 (or the connection module 109) in accordance with the ECHONET Lite communication protocol so as to set the input control information to the external device the activation of which has been detected (S507).

That is, when the control target device as the setting destination of the input control information is not selected, the setting module 303 sets the input control information to the external device the activation of which has been detected. In other words, when the control target device is not selected and identification information that coincides with the identification information of the external device the activation of which has been detected is not stored in the non-volatile memory 106, the setting module 303 sets the control information the input of which has been received by the receiver 300 to the external device the activation of which has been detected. With this configuration, even when the control target device as the setting destination of the control information input on the control information input screen G is not selected, the control information input by use of the control information input screen G before the activation of the external device is detected can be set to the external device the activation of which has been detected. This improves operability of the operation terminal 100 when the control information is set to the external device.

On the other hand, when the activation of the external device has not been detected (No at S506) and a previously set time has elapsed since the activation message has been displayed (Yes at S512), the setting module 303 finishes the processing of setting the control information to the external device.

In the embodiment, when the first button B1 on the control information input region R3 of the control information input screen G is touched and specified, the setting module 303 sets, to the external device the activation of which has been detected, the control information directing the shooting timing input by use of the timing input screen (not illustrated) and turning ON the timer shooting function of the external device (in the embodiment, the inside camera 200). On the other hand, when the second button B2 on the control information input region R3 of the control information input screen G is touched and specified, the setting module 303 sets, to the external device the activation of which has been detected, the control information directing to turn OFF the timer shooting function of the external device (in the embodiment, the inside camera 200).

The inside camera 200 receives the control information transmitted from the operation terminal 100. When the timer shooting function is directed to be turned ON with the received control information, the shooting timing directed by the received control information is stored in a storage module (not illustrated) comprised in the inside camera 200, and then, the power is turned OFF. Thereafter, the inside camera 200 is automatically activated and shoots the inside of the refrigerator at the shooting timing stored in the storage module (not illustrated). Then, the inside camera 200 is automatically powered OFF after the predetermined period of time has elapsed since the shooting of the inside of the refrigerator. On the other hand, when the timer shooting function is directed to be turned OFF with the received control information, the inside camera 200 deletes the shooting timing stored in the storage module (not illustrated) and cancels execution of the timer shooting function.

When the control information is set to the external device, the setting module 303 acquires the status information received from the external device upon detection of the activation of the external device and stores the control information set to the external device in the non-volatile memory 106 in association with the identification information (for example, the model number and the device address) of the external device (registered device) that is contained in the acquired status information (S508). As illustrated in FIG. 6, the display controller 302 controls to display the identification information (for example, “model name CAMERA” as the model name of the inside camera 200 and “device address 00:11:22:33:44:50” as the device address of the inside camera 200) of the external device that is contained in the acquired status information as the setting destination information displayed on the inside camera information region R2 of the control information input screen G and therefore updates display of the setting destination information (S509).

Thereafter, the display controller 302 controls to display a setting completion message (for example, “The setting of the timer shooting function has been completed. Please input an installation place.”) as a message for notifying the user of setting completion of the control information to the external device on the display screen 101b. Next, when setting the installation place is directed by use of the third button B3 on the installation place setting region R4 of the control information input screen G and the installation place is input on the installation place setting screen (not illustrated), the setting module 303 stores the input installation place in the non-volatile memory 106 in association with the identification information of the external device (registered device) (S510).

When the input installation place is stored in the non-volatile memory 106, the display controller 302 controls to display the input installation place (for example, “chiller”) on the camera selection region R1 of the control information input screen G, as illustrated in FIG. 6. Furthermore, the display controller 302 controls to display a fourth button B4 for directing to change of the installation place selected on the camera selection region R1 and a fifth button B5 for directing to delete the control information set to the external device corresponding to the installation place selected on the camera selection region R1 on the installation place setting region R4, as illustrated in FIG. 6.

When the fourth button B4 is touched and specified, the display controller 302 controls to display the installation place setting screen (not illustrated) on the display screen 101b. When the fourth button B4 is touched and specified and the installation place is input on the installation place setting screen (not illustrated), the setting module 303 changes the installation place stored in the non-volatile memory 106 in association with the identification information of the external device to the input installation place. When the fifth button B5 is touched and specified, the setting module 303 deletes the identification information of the external device and the control information and the installation place stored in association with the identification information from the non-volatile memory 106.

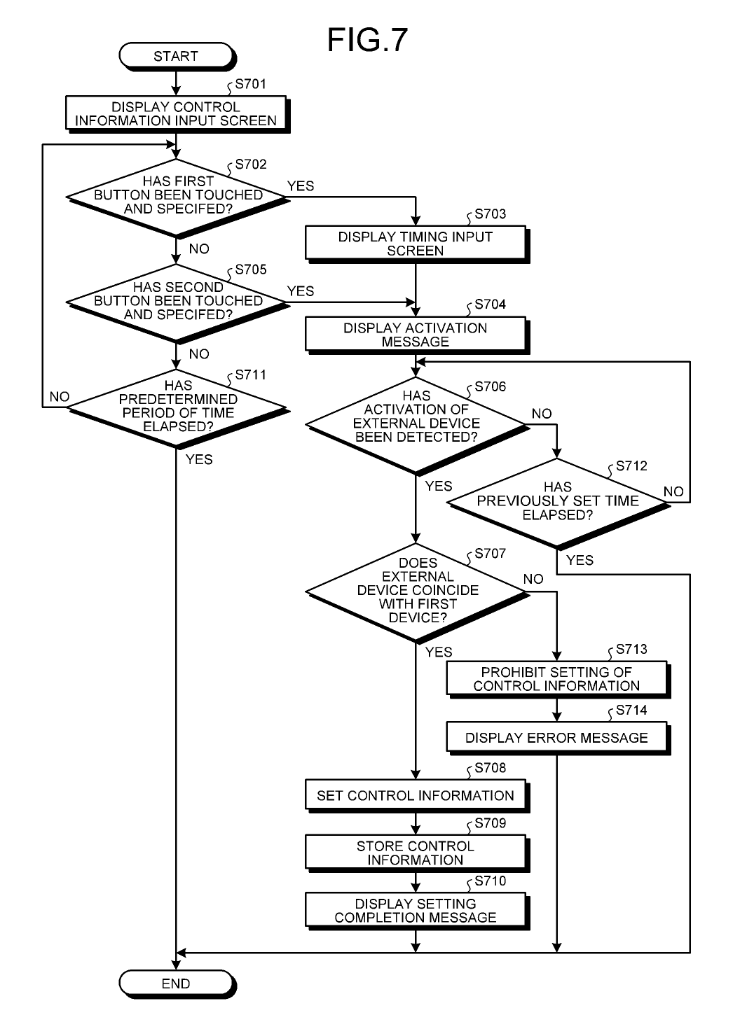

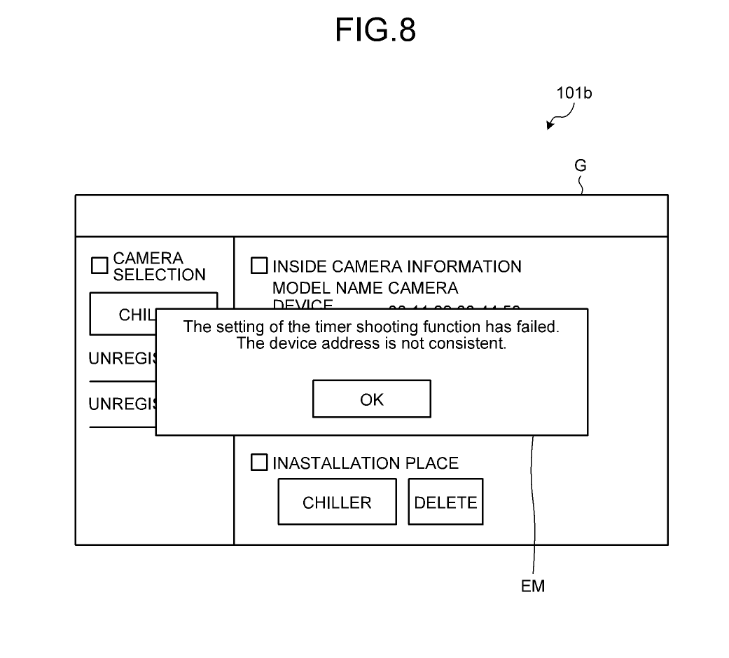

The following describes processing of setting the control information to the external device when the control target device as the setting destination of the control information is selected (when the installation place is selected on the camera selection region R1) with reference to FIGS. 6 to 8. FIG. 7 is a flowchart illustrating the flow of the processing of setting the control information to the external device by the operation terminal in the first embodiment. FIG. 8 is a view illustrating an example of an error message that is displayed on the operation terminal comprised in the information processing system in the first embodiment.

When setting the control information is directed through the touch panel 101a or the like, the display controller 302 controls to display the control information input screen G on the display screen 101b before the acquisition module 301 detects the external device (S701). In the embodiment, when the installation place (for example, “chiller”) is touched and specified on the camera selection region R1 of the control information input screen G and the control target device (registered device) as the setting destination of the control information is selected, the display controller 302 reads out identification information of the selected registered device (first device) from the non-volatile memory 106. Then, as illustrated in FIG. 6, the display controller 302 controls to display the setting destination information (for example, “model name CAMERA” as the model name of the inside camera 200 and “device address 00:11:22:33:44:50” as the device address of the inside camera 200) of the control target device (first device) selected as the setting destination of the control information on the inside camera information region R2 based on the read identification information.

Furthermore, the display controller 302 determines whether the first button B1 (“on”) displayed on the control information input region R3 of the control information input screen G has been touched and specified (S702). When the display controller 302 determines that the first button B1 has been touched and specified (Yes at S702), the display controller 302 controls to display the timing input screen (not illustrated) for inputting the shooting timing on the display screen 101b (S703). Thereafter, when the shooting timing is input and the OK button or the like directing to set the shooting timing is touched and specified on the timing input screen, the display controller 302 controls to display an activation message (for example, “Please activate the inside camera.”) directing to activate the external device on the display screen 101b (S704).

On the other hand, when the first button B1 has not been touched and specified (No at S702), the display controller 302 determines whether the second button B2 (“off”) displayed on the control information input region R3 of the control information input screen G has been touched and specified (S705). Then, when the display controller 302 determines that the second button B2 has been touched and specified (Yes at S705), the display controller 302 controls to display the activation message on the display screen 101b (S704). On the other hand, when the second button B2 has not been touched and specified (No at S705), the display controller 302 determines whether a predetermined period of time has elapsed since the first button B1 and the second button B2 have been displayed (S711). When the predetermined period of time has not elapsed since the first button B1 and the second button B2 have been displayed (No at S711), the process returns to S702 and the display controller 302 determines whether the first button B1 has been touched and specified. On the other hand, when the predetermined period of time has elapsed since the first button B1 and the second button B2 have been displayed (Yes at S711), the display controller 302 finishes display of the control information input screen G and finishes the processing of setting the control information to the external device.

After the activation message is displayed on the display screen 101b, the setting module 303 determines whether the acquisition module 301 has detected activation of the external device (S706). When the activation of the external device has not been detected (No at S706) and a previously set time has elapsed since the activation message has been displayed (Yes at S712), the setting module 303 finishes the processing of setting the control information to the external device. On the other hand, when the acquisition module 301 has detected the activation of the external device (Yes at S706), the setting module 303 determines whether the external device the activation of which has been detected by the acquisition module 301 and the first device (inside camera 200) selected as the setting destination of the control information coincide with each other (S707).

In the embodiment, the setting module 303 determines whether the external device and the first device coincide with each other by determining whether the identification information contained in the status information received from the external device by the acquisition module 301 and the identification information of the first device displayed as the setting destination information on the inside camera information region R2 of the control information input screen G coincide with each other.

When the external device and the first device coincide with each other (Yes at S707), the setting module 303 transmits the control information input by use of the control information input screen G to the external device the activation of which has been detected through the wireless communication I/F 110 (or connection module 109) in accordance with the ECHONET Lite communication protocol so as to set the input control information to the external device (S708).

In the embodiment, when the first button B1 on the control information input region R3 of the control information input screen G is touched and specified, the setting module 303 sets, to the external device the activation of which has been detected, the control information directing to turn on the timer shooting function of the external device (in the embodiment, the inside camera 200) and the shooting timing input by use of the timing input screen (not illustrated). On the other hand, when the second button B2 on the control information input region R3 of the control information input screen G is touched and specified, the setting module 303 sets control information directing to turn OFF the timer shooting function of the external device (in the embodiment, the inside camera 200) to the external device the activation of which has been detected. The processing in the inside camera 200 to when the control information is set is the same as contents as described with reference to FIG. 5.

When the control information is set to the external device, the setting module 303 acquires the status information received from the external device when activation of the external device has been detected and stores the control information set to the external device in the non-volatile memory 106 in association with the identification information (for example, the model number and the device address) of the external device (registered device) that is contained in the acquired status information (S709).

Thereafter, the display controller 302 controls to display the setting completion message (for example, “The setting of the timer shooting function has been completed.”) as a message for notification of setting completion of the control information to the external device on the display screen 101b (S710).

On the other hand, when the external device and the first device do not coincide with each other (No at S707), the setting module 303 prohibits the control information input by use of the control information input screen G from being transmitted to the external device so as to prohibit setting of the control information to the external device(S713). In addition, as illustrated in FIG. 8, the display controller 302 controls to display, on the display screen 101b, an error message EM (for example, “The setting of the timer shooting function has failed. The device address is not consistent.”) as an example of notification relating to the non-coincidence between the external device and the first device so as to overlap with the control information input screen G (S714).

Although the display controller 302 controls to display the error message EM on the display screen 101b so as to overlap with the control information input screen G in the embodiment, the display manner is not limited thereto. For example, the error message EM may be displayed instead of the control information input screen G.

Thus, the operation terminal 100 comprised in the information processing system in the first embodiment does not perform setting of the control information when the external device the activation of which has been detected does not coincide with the control target device selected as the setting destination of the control information input by use of the control information input screen G before the activation of the external device is detected. With this configuration, when the control information is input by use of the control information input screen G before the activation of the external device is detected, the control information can be set to the external device that is intended by the user without mistaking the external device selected as the setting destination of the control information.

### Second Embodiment

A second embodiment is an example where when an external device the activation of which has been detected does not coincide with a control target device selected as a setting destination of control information input by use of a control information input screen and the control target device coincides with a second device as a registered device to which control information has been set, a control input screen (an example of a second screen) as a screen (that can be used for changing the control information) for changing the control information that has been already set to the second device is displayed, prohibition of setting of the control information to the external device the activation of which has been detected is cancelled, and the control information changed by use of the control input screen is set to the external device. In the following description, explanation of the same contents as those in the first embodiment is omitted.

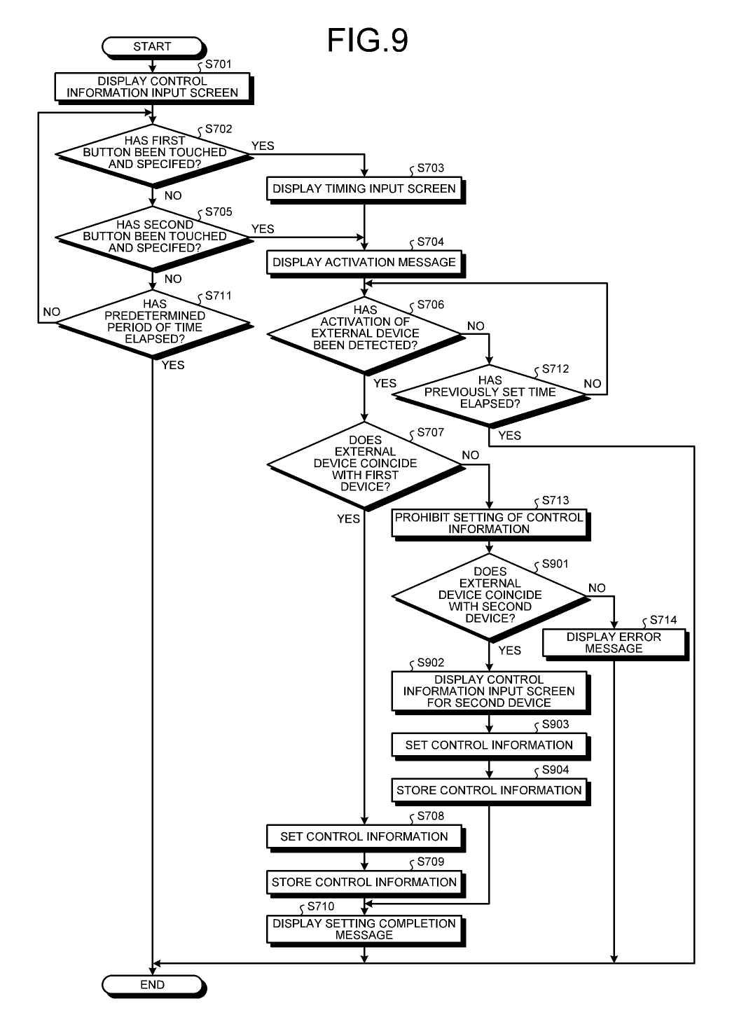

FIG. 9 is a flowchart illustrating the flow of processing of setting the control information to an external device by an operation terminal in the second embodiment. In the embodiment, when the external device and the first device do not coincide with each other and setting of the control information to the external device is prohibited, the setting module 303 determines whether the external device coincides with a second device as a registered device to which the control information has been already set (S901). In the embodiment, the setting module 303 determines whether the external device coincides with the second device by determining whether the identification information contained in the status information received from the external device by the acquisition module 301 does not coincide with the identification information of the first device and coincides with any of pieces of identification information of the second devices as the registered devices that are stored in the non-volatile memory 106.

When the external device and the second device coincide with each other (Yes at S901), the display controller 302 controls to display, on the display screen 101b, the control information input screen G (an example of the second screen as a screen for changing the control information that has been already set to the second device) when the second device has been selected as the setting destination of the control information (S902).

The display controller 302 may control to display, on the display screen 101b, an image for notification of a fact that the external device does not coincide with the first device but coincides with the second device to which the control information has been already set before display of the control information input screen G as an example of the second screen on the display screen 101b. For example, “The device address is not consistent with an device address of an inside camera in a refrigerator but is consistent with an device address of an inside camera in a vegetable compartment. Is the screen to be switched to the control information input screen G for the inside camera in the vegetable compartment?” may be displayed as the image. Thereafter, when display of the control information input screen G for the second device is directed through the touch panel 101a, the display controller 302 may control to display, on the display screen 101b, the control information input screen G when the second device has been selected as the setting destination of the control information.

The setting module 303 transmits the control information changed by use of the control information input screen G when the second device has been selected as the setting destination of the control information to the external device through the wireless communication I/F 110 (or connection module 109) in accordance with the ECHONET Lite communication protocol so as to set the changed control information to the external device (S903). That is, the setting module 303 cancels prohibition of setting of the control information to the external device and sets the changed control information to the external device.

When the changed control information is set to the external device, the setting module 303 stores the changed control information in the non-volatile memory 106 in association with identification information (for example, a model number and an device address) of the second device (S904). Thereafter, the display controller 302 controls to display a setting completion message as a message for notification of setting completion of the control information to the external device on the display screen 101b (S710).

On the other hand, when the external device and the second device do not coincide with each other (No at S901), as illustrated in FIG. 8, the display controller 302 controls to display, on the display screen 101b, an error message EM as an example of an image for notification of a fact that the external device and the second device do not coincide with each other so as to overlap with the control information input screen G (S714).

Thus, the operation terminal 100 comprised in the information processing system in the second embodiment can change the control information set to the external device to the control information input by use of the control information input screen G for the second device when the external device activated by the user who intends to change the control information coincides with the second device as the registered device to which the control information has been already set even in the case where the external device does not coincide with the first device selected as the setting destination of the control information input by use of the control information input screen G. This enables the control information of the external device activated by the user who intends to change the control information to be changed.

### Third Embodiment

A third embodiment is an example where when an external device the activation of which has been detected does not coincide with a first device as a control target device selected as a setting destination of control information input by use of a control information input screen and any of second device as registered devices to which pieces of control information have been already set and the number of second devices is smaller than a predetermined number, a third screen (that can be used for inputting control information) for inputting control information to be set to the external device is displayed and control information input by use of the third screen is set to the external device the activation of which has been detected. In the following description, contents that are different from those in the second embodiment are explained.

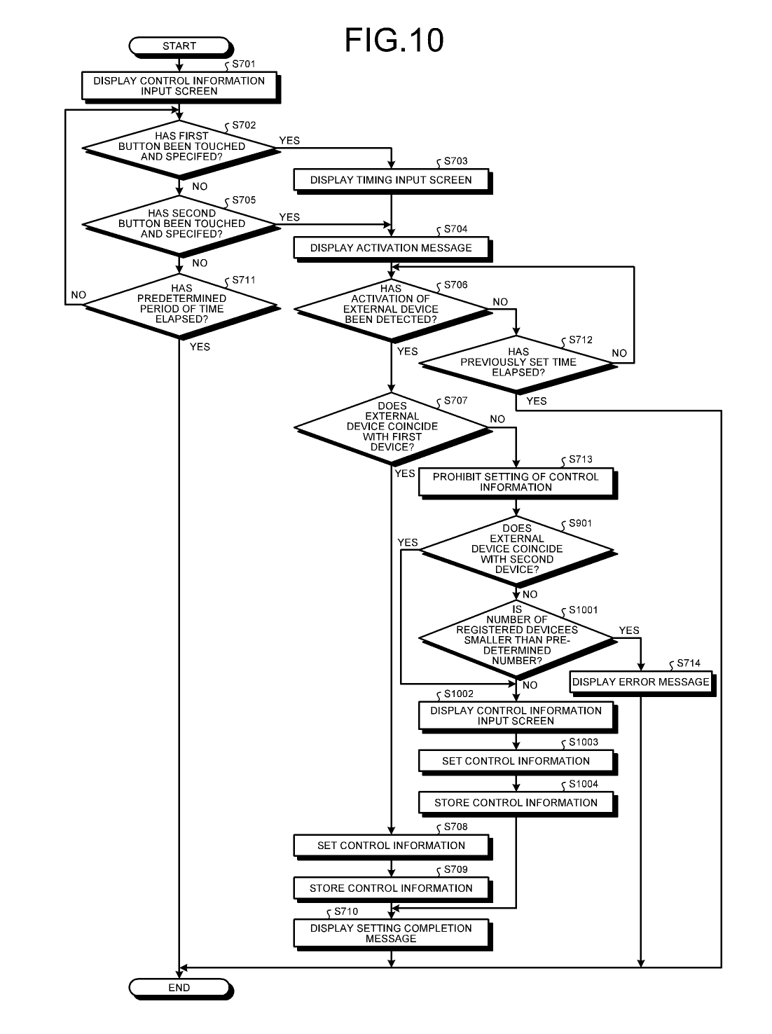

FIG. 10 is a flowchart illustrating the flow of processing of setting the control information to the external device by an operation terminal in the third embodiment. In the embodiment, when the external device and the second device coincide with each other (Yes at S901), the setting module 303 controls to display a control information input screen G when the second device has been selected as the setting destination of the control information on the display screen 101b (S1002) in the same manner as the second embodiment (S1002). Then, the setting module 303 transmits the control information changed by use of the control information input screen G when the second device has been selected as the setting destination of the control information to the external device the activation of which has been detected through the wireless communication I/F 110 (or connection module 109) in accordance with the ECHONET Lite communication protocol so as to set the changed control information to the external device (S1003). When the changed control information is set to the external device the activation of which has been detected, the setting module 303 stores the changed control information in the non-volatile memory 106 in association with identification information (for example, a model number and an device address) of the external device (second device) (S1004). Thereafter, the display controller 302 controls to display a setting completion message as a message for notification of setting completion of the control information to the external device on the display screen 101b (S710).

On the other hand, when the external device and the second device do not coincide with each other (No at S901), the setting module 303 determines whether the number of registered devices is smaller than the predetermined number (S1001). In the embodiment, the setting module 303 determines whether the number of registered devices is smaller than the predetermined number by determining whether the number of pieces of identification information (pieces of identification information of the registered devices) stored in the non-volatile memory 106 has reached the predetermined number.

When the number of registered devices to which pieces of control information have been set has reached the predetermined number (Yes at S1001), as illustrated in FIG. 8, the display controller 302 controls to display, on the display screen 101b, an error message EM as an example of an image for notification of a fact that the external device and the second devices do not coincide with each other so as to overlap with the control information input screen G (S714).

On the other hand, when the number of registered devices has not reached the predetermined number (No at S1001), the display controller 302 controls to display, on the display screen 101b, the control information input screen G (see FIG. 4) when “unregistered” is touched and specified on the camera selection region R1 (that is, when the control target device as the setting destination of the control information is not selected) as a third screen for inputting the control information that is set to the external device (S1002).

The display controller 302 may control to display, on the display screen 101b, an image for notification of a fact that the external device does not coincide with the second device but a new external device can be registered newly before controlling to display the control information input screen G as the third screen on the display screen 101b. For example, “The device address is not consistent with an device address of an inside camera in a refrigerator but a new inside camera can be registered. Is the screen to be switched to a control information input screen for the new inside camera?” may be displayed as the image. Thereafter, when the control information input screen G for the external device is directed to be displayed through the touch panel 101a, the display controller 302 controls to display, on the display screen 101b, the control information input screen G when the external device has been selected as the setting destination of the control information as the third screen.

The setting module 303 transmits the control information input by use of the control information input screen G to the external device the activation of which has been detected through the wireless communication I/F 110 (or connection module 109) in accordance with the ECHONET Lite communication protocol so as to set the input control information to the external device (S1003). That is, the setting module 303 cancels prohibition of setting of the control information to the external device and sets the control information input by use of the third screen to the external device.

When the control information is set to the external device, the setting module 303 acquires the status information received from the external device when activation of the external device has been detected, and stores the control information set to the external device in the non-volatile memory 106 corresponding to the identification information (for example, the model number and the device address) of the external device that is contained in the acquired status information (S1004). Thereafter, the display controller 302 controls to display the setting completion message as a message for notification of setting completion of the control information to the external device on the display screen 101b (S710).

Thus, the operation terminal 100 comprised in the information processing system in the third embodiment can set the control information input by use of the control information input screen G for the external device to the external device the activation of which has been detected when the number of registered devices to which pieces of control information have been set does not reach the predetermined number even in the case where the external device activated by the user who intends to change the control information does not coincide with the registered devices to which pieces of control information have been set. In this way, the control information can be set to the external device activated by the user who intends to change the control information.

As described above, according to the first to third embodiments, when the control information is input by use of the control information input screen G before the activation of the external device is detected, the control information can be set to the external device that is intended by the user without mistaking the external device selected as the setting destination of the control information.

The computer program that is executed on the operation terminal 100 in the embodiment is embedded and provided in the non-volatile memory 106 such as a read only memory (ROM) in advance. Alternatively, the computer program that is executed on the operation terminal 100 in the embodiment may be recorded and provided in a computer-readable recording medium such as a compact disc read only memory (CD-ROM), a flexible disk (FD), a compact disc recordable (CD-R), and a digital versatile disc (DVD), as an installable or executable file.

The computer program that is executed on the operation terminal 100 in the embodiment may be stored in a computer connected to a network such as the Internet and provided by being downloaded via the network. Furthermore, the computer program that is executed on the operation terminal 100 in the embodiment may be provided or distributed via a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a receiver configured to receive a selection of a control target device and an input of control information to be set for the control target device;
a display controller configured to control display of a first screen for inputting the control information on a display;
an acquisition module configured to detect an activated external device and acquire a unique identifier after the receiver receives the input of the control information;
storage configured to store the unique identifier for each registered device for which the control information is already set; and
a setting module configured to set the received control information for the external device when a first device of the registered device is selected as the control target device and the identifier of the external device coincides with the identifier of the first device, wherein
when the identifier of the first device does not coincide with the identifier of the external device, the display controller is configured to control display of a notification relating to non-coincidence on the display.

2. The information processing device of claim 1, wherein
the receiver is further configured to receive the input of the control information even when the control target device is not selected, and
when the control target device is not selected and no identifier coinciding with the identifier of the detected external device is stored in the storage module, the setting module is configured to set the received control information for the external device.

3. The information processing device of claim 1, wherein
when the identifier of the external device does not coincide with the identifier of the first device and coincides with the identifier of a second device of the registered devices, the display controller is configured to control display of a second screen on the display for changing the control information set for the second device, and
the setting module is configured to set the control information for the external device.

4. The information processing device of claim 3, wherein the display controller is configured to control display of an image notifying a fact indicating that the external device coincides with the second device on the display before displaying the second screen.

5. The information processing device of claim 1, wherein
when no identifier coinciding with the identifier of the external device is stored in the storage module and the number of the registered devices is smaller than a number, the display controller is configured to control display of a third screen for inputting the control information for setting for the external device on the display, and
the setting module is configured to set the control information for the external device.

6. The information processing device of claim 5, wherein the display controller is configured to control display of an image notifying a fact that the external device is capable of a new registration on the display before displaying the third screen.

7. The information processing device of claim 1, wherein when the identifier of the external device does not coincide with the identifier of the second device, the display controller is configured to control display of an image notifying a fact that the external device does not coincide with the second device on the display.

8. The information processing device of claim 1, wherein the first screen comprises identification information capable of identifying the first device.

9. A computer program product having a non-transitory computer readable medium including programmed instructions, wherein the instructions, when executed by a computer, cause the computer to perform:
receiving a selection of a control target device and an input of control information to be set for the control target device;
controlling display of a first screen for inputting the control information on a display;
detecting an activated external device and acquiring a unique identifier after receiving the input of the control information;
storing the unique identifier for each registered device for which the control information is already set;
setting the control information for the external device when a first device of the registered device is selected as the control target device and the identifier of the external device coincides with the identifier of the first device; and
further controlling display of a notification relating to non-coincidence on the display when the identifier of the first device does not coincide with the identifier of the external device.

10. The computer program product of claim 9, wherein the instructions cause the computer further perform:
receiving the input of the control information even when the control target device is not selected; and
setting the control information for the external device when the control target device is not selected and no identifier coinciding with the identifier of the detected external device is stored in the storage module.

11. The computer program product of claim 9, wherein the instructions cause the computer further perform:
when the identifier of the external device does not coincide with the identifier of the first device and coincides with the identifier of a second device of the registered devices, controlling display of a second screen for changing the control information set for the second device; and
setting the control information for the external device.

12. The computer program product of claim 11, wherein the instructions cause the computer further perform:
controlling display of an image notifying a fact indicating that the external device coincides with the second device on the display before displaying the second screen.

13. The computer program product of claim 9, wherein the instructions cause the computer further perform:
when no identifier coinciding with the identifier of the external device is stored in the storage module and the number of registered devices is smaller than a number, controlling display of a third screen for inputting the control information for setting for the external device on the display; and
setting the control information for the external device.

14. The computer program product of claim 13, wherein the instructions cause the computer further perform:
controlling display of an image notifying a fact that the external device is capable of a new registration on the display before displaying the third screen.

15. An information processing method that is executed by an information processing device comprising a storage module configured to store a unique identifier for each registered device for which control information for a control target device is already set, the information processing method comprising:
receiving a selection of the control target device and input of the control information to be set for the control target device;
controlling display of a first screen for inputting the control information on a display;
detecting an activated external device and acquiring the unique identifier after receiving the input of the control information;
setting the control information for the external device when a first device of the registered device is selected as the control target device and the identifier of the external device coincides with the identifier of the first device; and
controlling display of a notification relating to non-coincidence on the display when the identifier of the first device does not coincide with the identifier of the external device.
